(19) United States
(12) Patent Application Publication
(10) Pub. No.: US 2014/0138470 A1
(43) Pub. Date: May 22, 2014

(54) STRAP WRAPPER AND METHOD OF USE

(71) Applicant: Michael S. Bunting, Reno, NV (US)

(72) Inventor: Michael S. Bunting, Reno, NV (US)

(21) Appl. No.: 14/076,898

(22) Filed: Nov. 11, 2013

Related U.S. Application Data
(60) Provisional application No. 61/727,698, filed on Nov. 17, 2012.

(51) Int. Cl. B60P 7/08

(52) U.S. Cl. CPC B60P 7/0846
USPC 242/390

(57) ABSTRACT

A strap wrapper comprising a support plate, the support plate being rectangular with two ends, the one end allows the support plate to attach to an object, the other end is traversed by a double open-ended support channel; a rolling spindle, the rolling spindle having a base that supports a pair of spindle arms having a U-shaped orientation; a spindle driveshaft; the spindle driveshaft having one shall end and an other shaft end, the spindle driveshaft being movably received within the double-open ended tube, the one shall end connects to the rolling spindle while the other shall end can reversibly connect to a power tool that can rotate the spindle driveshaft, the power tool having a use apart and separate from powering the strap wrapper; wherein a webbed strap reversibly attaches to the rolling spindle to be coiled when the power tool is activated.

### U.S. NON-PROVISIONAL PATENT APPLICATION

STRAP WRAPPER AND METHOD OF USE

### STATEMENT REGARDING FEDERALLY SPONSORED RESEARCH OR DEVELOPMENT

Not Applicable

### REFERENCE TO A “MICROFICHE APPENDIX

Not Applicable.

### FIELD OF THE INVENTION

The present invention relates to those devices that are used to coil webbed straps that may be used to secure loads. More particularity to those strap wrapping devices that are powered.

### BACKGROUND

The transportation industry in which loads are transported by load-bearing devices (e.g., flatbed vehicles, etc.) may use webbed straps to secure such loads to the load-bearing devices. These webbed straps are generally laid laterally across a flatbed (and over the top of their load[s]) to allow the ends of the straps to be secured to the side/side edges of the flatbed. The webbed strap may have one end with a metal hook/chain that may reversibly attach to a fixture on one side edge while other end of the strap may reversibly feed into a ratchet roller located on the other side edge of the flat bed. When the hook/chain end is appropriately secured, the ratchet roller may be hand-cranked to revolve its roller to generally wind the webbed strap's other end around the roller so as to tighten down the webbed strap upon the load to reversibly secure the load to the flatbed.

When the vehicle has reached the destination for off-loading the transported load, the ratchet roller may be operated in a manner (e.g., releasing the ratchet) that allows the roller to revolve and release the webbed strap. In this manner, the webbed strap can be released/removed from the vehicle to allow the load to be shifted about/removed from the flatbed.

In today's cartage environment, when seconds may count relative to profit and when load safety and security are heavily governmentally and privately regulated, the use and storage of load-securing devices such as webbed straps may be significantly controlled. When the webbed strap is not in use, it could be rolled or coiled up into a compact state for storage. In this manner, several such webbed straps for a transport vehicle can be placed in a compact storage space to make them available for immediate use later. Keeping the coiled/wrapped/rolled webbed straps stored in this orderly manner (rather than bunching them up and stuffing them in a storage space) may also reduce their wear and tear; further extend their useful lifespan; and allow additional items be placed in the storage space.

The operator may roll the webbed straps by hand, although due to the nature and length of the webbed strap and the number of straps to be rolled, this task may require a significant period of time to accomplish. Further, the constant and repetitive hand rolling action may lead to repetitive action injuries (e.g. metacarpal tunnel syndrome) for the operator.

As substantially shown in FIG. 1, one possible solution to the hand rolling of the webbed straps could be a manually-powered rolling device known as the Strap Winder, model number SW5000, 10 as provided by US Cargo Control 202 Blue Creek Drive Urbana, Iowa 52345. The Strap Winder 10 could comprise of a double-ended support arm 12, a wrapping spindle 14 and a hand crank 16. The support arm 12 could have one support end 18 forming a U-shaped cup 20 that allows the one support end 18 could slip over and hold onto an edge 200 of a load-bearing device 202 (e.g., shelving, flatbed and the like) to support the device 10. The one support end 18 could be further penetrated by a fastener 22 that could reversibly impinge upon edge 200 to hold a portion of the edge 200 within the U-shaped cup 20. The other support end 24 could have located along its furthermost edge a double-open ended tube 26.

The hand crank 16 could have a shaft 28 connected in an offset manner to a handle 30. The shaft 28 could be rotatably inserted into the double-open ended tube 26 so that the shaft's end protrudes out from the double-open ended tube 26. The shaft's end could then attach to the wrapping spindle 14 to affix the wrapping spindle 14 to the hand crank 16. The wrapping spindle 14 could feature a pair of rods 32 that are held in parallel, yet spaced-apart orientation to one another. An unattached end 206 of a webbed strap 204 to be rolled by the strap wrapper 10 could be inserted between the rods 32 so that by turning the hand crank 16, the remainder of the webbed strap 204 may be subsequently wrapped around the rods 32 forming a coil or roll. When the webbed strap 204 is fully wrapped (e.g., formed in to a roll/coil) around the wrapping spindle 14, the formed strap roll/coil can be pulled off the wrapping spindle 14 (e.g., to be placed in storage.)

One possible issue with this strap winder device could be its manual operation. A relatively large diameter hand crank used to power the device may call for significant amount of movement on the part of the operator; still require a significant amount of time to operate; and in a long term application, may cause a repetitive trauma injury to the operator. What could be needed is a strap wrapper that could be easily configured to be operated by a power tool.

### SUMMARY OF ONE EMBODIMENT OF THE INVENTION

### Advantages of One or More Embodiments of the Present Invention

The various embodiments of the present invention may, but do not necessarily, achieve one or more of the following advantages:

to provide a manually-operated strap wrapper that can be easily converted to being operated by a power tool to reduce the time it takes to wrap or coil a webbed strap;

the ability to wrap a webbing strap into a coil or a roll using a power tool;

to provide a spindle driveshaft that adapts a manually-operated strap wrapper to be driven by a power tool;

the ability to quickly, inexpensively and easily adapt a manually-operated strap wrapper to be driven by a power tool that has another use outside of that of powering the strap wrapper:

to provide a spindle driveshaft that replaces a hand crank of a manually-operated strap wrapper to allow the strap wrapper to be driven by a power tool to reduce operator fatigue and possible injury; and

to provide a spindle driveshaft with a collar that helps rotatably hold a support arm between the collar and the rolling spindle for the operation of a strap wrapper.

These and other advantages may be realized by reference to the remaining portions of the specification, claims, and abstract.

### Brief Description of One Embodiment of the Present Invention

One possible embodiment of the invention could be a strap wrapper comprising a support plate, the support plate being rectangular with two ends, the one end allows the support plate to attach to an object, the other end is traversed by a double open-ended support channel; a rolling spindle, the rolling spindle having a base that supports a pair of spindle arms having a u-shaped. spaced-apart, parallel-orientation; a spindle driveshaft; the spindle driveshaft having one shaft end and an other shaft end, the spindle driveshaft being movably received within the double-open ended tube, the one shaft end connects to the rolling spindle while the other shaft end can reversibly connect to a power tool that can rotate the spindle driveshaft, the power tool having a use apart and separate from powering the strap wrapper; wherein a webbed strap, which is used to reversibly secure loads to a load bearing device, reversibly attaches to the rolling spindle to be coiled when the power tool as attached to the strap wrapper is activated.

Another possible embodiment of the invention could be a strap wrapper and power tool to combination comprising a strap wrapper having a support plate, a rolling spindle and a spindle driveshaft, the support plate at one end is traversed by a double open-ended channel that rotatably supports the spindle driveshaft; the spindle driveshaft having two shaft ends, one shaft end attaches the rolling spindle while other shaft end allows a power tool to attach to the spindle driveshaft; the power tool having a use apart and separate from powering the strap wrapper, when activated the power tool rotates the spindle driveshaft relative to the double open-ended channel to move the rolling spindle; wherein a webbing strap as reversibly attached to the rolling spindle is wrapped into a coil when the rolling spindle is rotated by the power tool, the power tool having a use apart and separate from powering the strap wrapper.

Yet another possible embodiment of the invention could be a process for operating a strap wrapper, comprising the following steps but not necessarily in the order presented: providing a support plate having two ends, one end allows the support plate to attach to other objects, a double open-ended support channel traversing an other end; providing a rolling spindle, the rolling spindle having a base that supports a pair of spindle arms having a spaced-apart. opposing, parallel-orientation; providing a spindle driveshaft; the spindle driveshaft having one shaft end and an other shaft end, the spindle driveshaft being movably received in the double open-ended channel, the one shaft end connects to rolling spindle while the other shaft end can reversibly connect to a power tool that can rotate spindle driveshaft; connecting the power tool to the spindle driveshaft to rotate the rolling spindle, the power tool having a use apart and separate from powering the strap wrapper; attaching to the rolling spindle a webbed strap that can he used to secure a load to a load bearing device; and rotating the spindle driveshaft with the power tool to coil the webbed strap

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a cutaway perspective view of one embodiment of the prior art.

FIG. 2 is substantially a cutaway perspective view of one embodiment of the present invention.

FIG. 3 is substantially a cutaway view of one embodiment of support plate of the present invention.

FIG. 4 is substantially a perspective view of one embodiment of rolling spindle of the present invention.

FIG. 5 is substantially a perspective cutaway view of the present invention showing the spindle driveshaft.

FIG. 6 is substantially a perspective cutaway view of one embodiment of hand crank, rolling spindle, support plate of the present invention.

FIG. 7 is substantially a schematic flowchart of one embodiment of process for operating the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

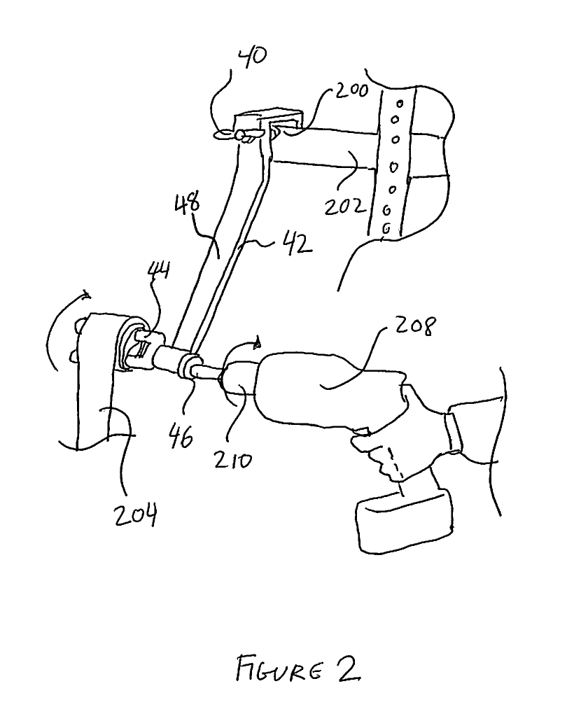

The present invention 40 could comprise of a strap wrapper 42 and a method of use 100. As substantially shown in FIG. 2, the strap wrapper 42 could comprise of a rolling spindle 44 coupled to a spindle driveshaft 46 rotatably held by a support plate 48. The support plate 48 could reversibly attach to a portion of an edge 200 of a load bearing device 202 (e.g., a flatbed, shelving and the like.) A power tool 208, such as cordless drill, could reversibly attach by its chuck 210 to the spindle driveshaft 46 to power the strap wrapper 42 (e.g. rotate the rolling spindle 44) to wrap the webbed strap 204 around the rolling spindle 44. The power tool could is have a use that is separate and apart from powering the strap wrapper.

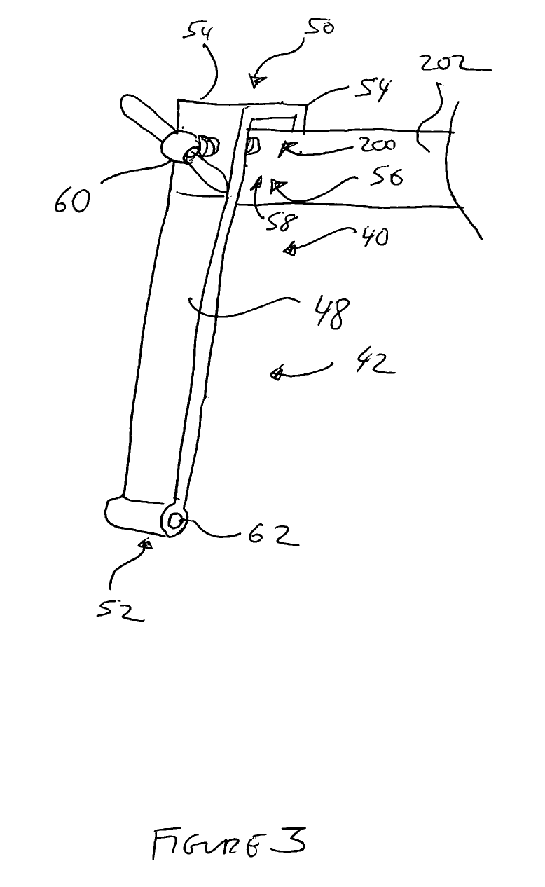

As substantially shown in FIG. 3, the support plate 48 could be rectangular and made of suitable material such as steel. The support plate 48 could terminate at pair of plate ends, an one plate end 50 and an other plate end 52. The one plate end 50 could be adapted to reversible receive and hold a portion of an edge 200 of a load bearing device 202 to allow the support plate 48 to be supported by the load-bearing device 202. This one plate end 50 could be formed with two (2) parallel bends 54 to designate three continuously connected end sections that form a U-shape holder 56 denoting a generally hollow interior 58 that could receive a portion of the edge 200. A threaded fastener 60 could reversibly penetrate the U-shape holder 56 into the hollow interior 58 to allow the threaded fastener 60 to impinge against an edge 200 to substantially pin a portion of the edge 200 against the end section of the U-shape holder 56. In other embodiments, other suitable means (e.g., a hinged clamp, ceramic magnets, and the like-not shown) could be employed to generally hold the support plate 48 onto the load-bearing device 202. The other plate end 52 could have a double open-ended support channel 62 traversing its outermost edge for movably housing a portion of the spindle driveshaft 46 (generally shown in FIG. 2.)

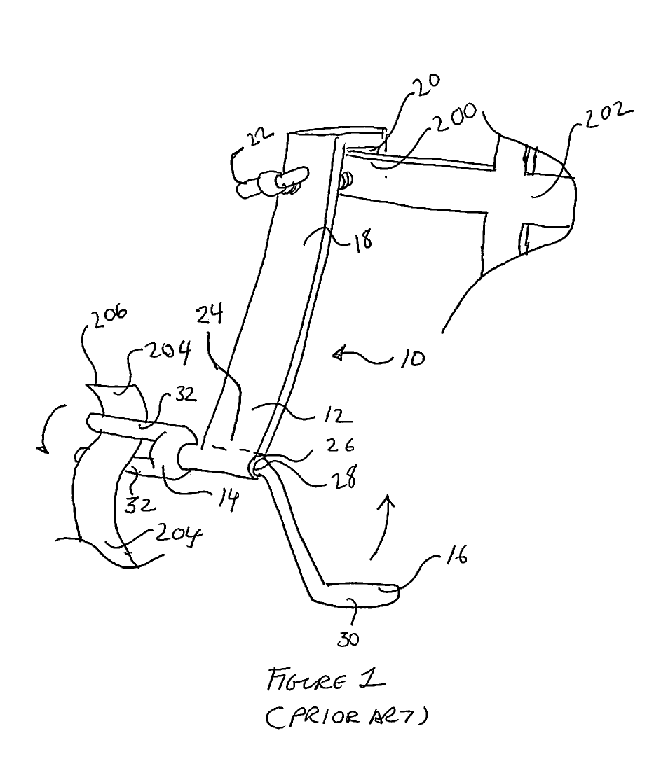

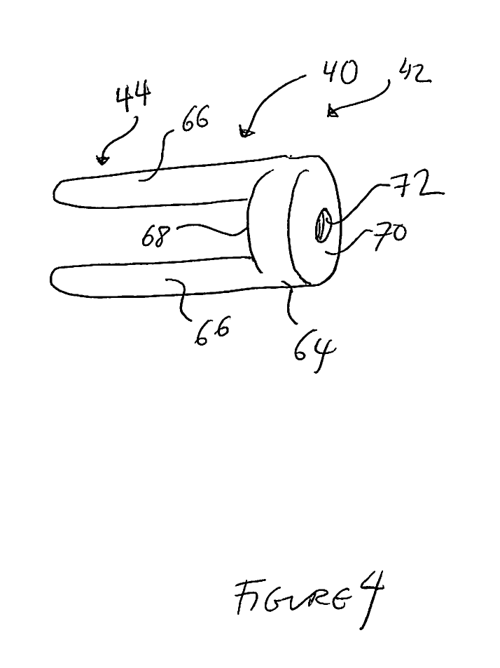

As substantially shown in FIG. 4, the rolling spindle 44 feature a base 64 supporting a pair of spaced-apart, opposing spindle arms 66. The base 64 could have a top 68 and a bottom 70 with the pair of spindle arms 66 projecting upward from the top 68 in a spaced-apart, parallel (e.g., U-shaped) configuration. A threaded base aperture 72 could be located on the bottom 70 to generally allow the rolling spindle 44 to be attached to the one shall end 74 (e.g., threaded) of the spindle driveshaft 46. The length of the spindle arms 66 should he sufficient to substantially accommodate the width of the straps 204 (generally shown in FIG. 1.) The rolling spindle 44 could be made of suitable material such as aluminum, steel, resilient polymer and the like. In operation, the open/unattached strap end 206 (generally shown in FIG. 2) to be wrapped by the invention 40 could be inserted between the spindle arms 66 and wrapped subsequently around the rolling spindle 44 one or two turns to substantially ensure that the strap's open end 206 would not prematurely slip off the rolling spindle 44 during the wrapping operation.

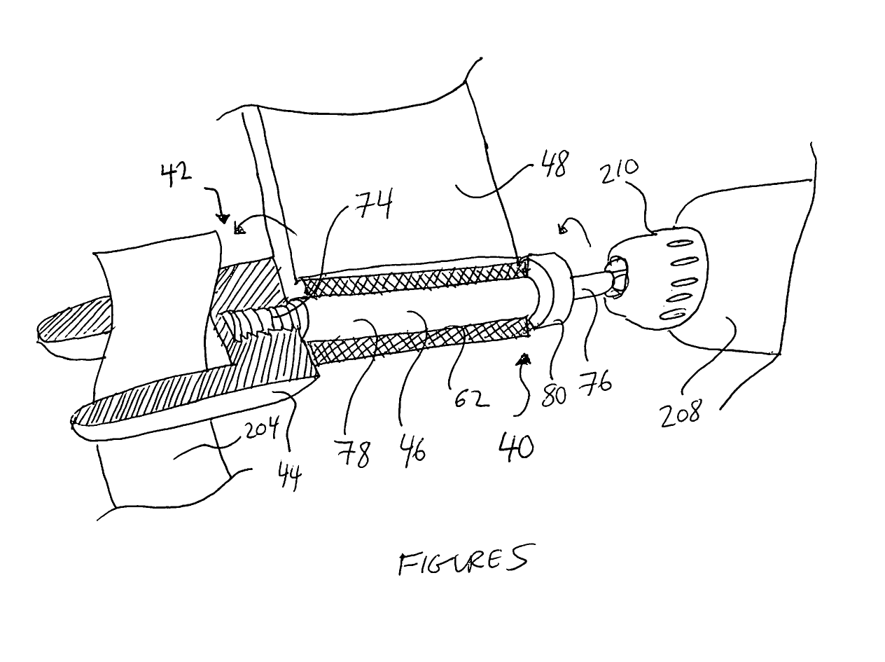

As substantially shown in FIG. 5, the spindle driveshaft 46 could be a definite length of rod terminating in a pair of shaft ends. One shaft end 74 could have a diameter that is the same as or less than the diameter of the double open-ended support channel 62 to allow the one shaft end 74 to pass through the support. The one threaded shaft end 74 could further be threaded to allow it to reversibly attach to the threaded base aperture 72, generally connecting the rolling spindle 44 to the spindle driveshaft 46. The one threaded shall end 74 could be supported by a central portion 78 that could have the same length as the double open-ended support channel 62 and generally have the same diameter as well (e.g., to the extent needed to allow the central portion 78 to pass into and freely rotate within the double open-ended support channel 62.) In between the central portion 78 and the other shaft end 76 could be located a retaining collar 80 that has a diameter that is larger than the diameter of the double open-ended support channel 62. The retaining collar 80 could prevent the spindle driveshaft 46 from fully passing through the double open-ended support channel 62 in one direction. The rolling spindle 44, as attached to the one threaded shaft end 74, could likewise prevent the spindle driveshaft 46 from fully passing through the double open-ended support channel 62 in the other direction. In this manner, the double open-ended support channel 62 could be substantially sandwiched in between the retaining collar 80 and the attached rolling spindle 44. The other shaft end 76 could be of suitable size, shape and diameter to allow a power tool 208 (e.g., the jaws of a chuck 210 of power tool 208) to reversible attach to the spindle driveshaft 46 and power the strap wrapper 42 (e.g., rotate the spindle driveshaft 46/attached rolling spindle 44 to wrap a webbed strap 204 into a coil/roll.)

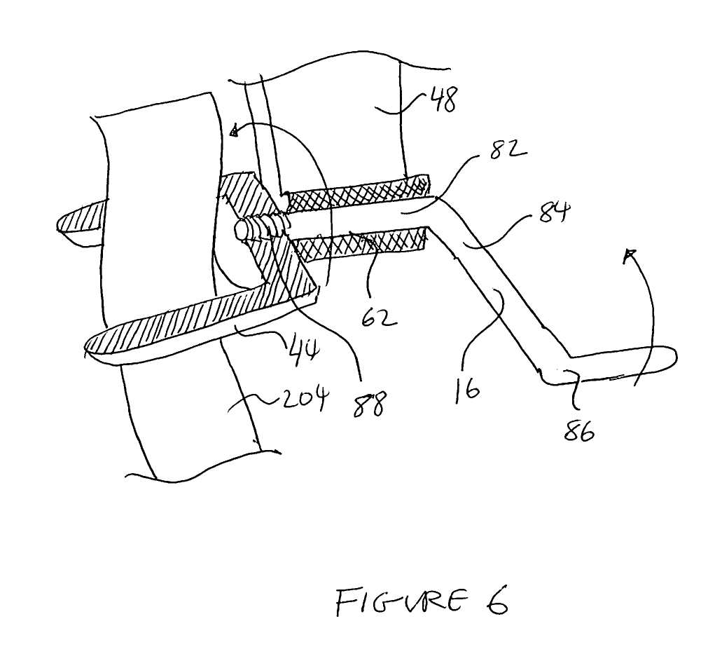

As substantially shown in FIG. 6, one embodiment, the spindle driveshaft 46 (generally shown in FIG. 5) could be a replacement for a hand crank 16 that could come with the strap wrapper 42 for manual operation of the strap wrapper 42. The hand crank 16 could be S-shaped rod denoting a tube shaft 82 that is offset connected by a connection arm 84 to a turning handle 86. The tube shaft 82 could have a threaded tube shaft end 88 that could protrude from the double open-ended support channel 62 to reversibly attach the hand crank 16 to the rolling spindle 44. The rotating of the hand crank 16 by its turning handle 86 would rotate a portion of the tube shaft 82 within the double open-ended support channel 62 to rotate the rolling spindle 44 and wrap the attached strap 204 around the rolling spindle 44.

When the strap 204 is fully wrapped around the rolling spindle, the webbed strap 204 when coiled/rolled can then be pulled off the rolling spindle 44 and be placed in storage until subsequently needed.

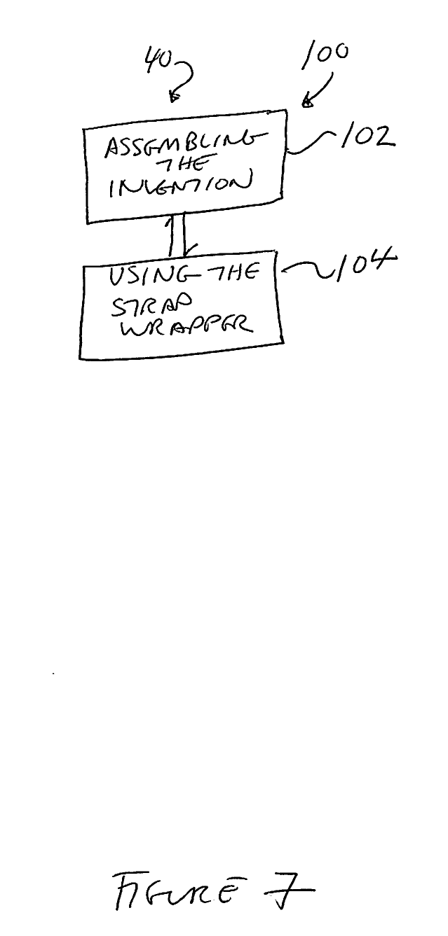

As substantially shown in FIG. 7, one possible embodiment could be a process 100 for the operation of the invention 40 that could start with step 102, assembling the invention. In this step, the strap wrapper is initially assembled with the manually-powered hand crank. As such, the rolling spindle could be unwound/unthreaded from the hand crank. The hand crank could be removed from the double open-ended support channel (e.g., of the support arm) and set aside. The central portion of the spindle driveshaft could be appropriately lubricated could be inserted (via its threaded end) into the double open-ended support channel until the retaining collar impedes further movement of the spindle driveshaft through the channel. The base aperture of the spindle can be threaded upon the one shalt end (threaded) until the rolling spindle is secured onto the spindle driveshaft. The double open-ended support channel can then be seen as is generally sandwiched between the rolling spindle and the retaining collar.

In another version, when the strap wrapper is assembled, the strap wrapper is assembled using the support plate and spindle driveshaft, sans hand crank. The assemble process takes place without the steps of un-attaching hand crank from the rolling spindle and the withdrawal of the hand crank from the channel.

When this step is substantially completed, the process 100 could proceed to step 104, using the strap wrapper.

In step 104, using the strap wrapper, the one (e.g., U-shaped) end of the support arm could be placed upon the portion of the edge of the load bearing device. The threaded fastener could pin the portion of the edge to an opposing segment to reversibly, yet securely, affix the strap wrapper to the load-bearing device. A power rotary tool (e.g., cordless or battery-operated drill) could be attached (e.g., by the drill's chuck) onto the other shaft end. The webbed strap (to be wound into a roll or coil) could have its open end inserted through the open space created between the opposing spindle arms. The webbed strap's open end could be further wrapped around the outside the spindle arms to initially secure the webbed strap to the rolling spindle. The operator could hold and operate the power drill with one hand and carefully and lightly hold down on a portion of the strap to be wrapped. As the power drill is activated and rotates the to rolling spindle to take up the remaining portion of webbed strap, the operator could allow the remaining portion to gently run through his other hand to maintain a light tension on the remaining portion of the webbed strap as it is wrapped upon the rolling spindle. Generally, the operation of the strap wrapper should be done in a manner (e.g., rotating the hand crank or the spindle driveshaft by the power drill) causes rolling spindle to be tighten down upon the crank/spindle driveshaft during wrapping operations.

When the webbed strap is substantially wrapped about the rolling spindle, the power drill can be stopped. Because the rolling spindle is open-ended, the webbed strap (around and between the spindle arms) can be pulled off as a coil/roll and suitably stored as needed. If another webbed strap needs to be winded, rolled or coiled, the process 100 could repeat step 104. If no additional webbed straps need to be winded, rolled or coiled, the process 100 could reverse itself to dissemble and the suitably store the strap wrapper.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

As generally shown in this application the invention could be seen a manually operated/powered strap wrapper and method for its use. The strap wrapper could replace its hand crank (if so supplied) with a spindle driveshaft that connects the rolling spindle with a powered tool to drive the strap wrapper. This spindle driveshaft, being simple; easy-to-make and easy-to-operate, connects a powered source to the strap wrapper to operate the strap wrapper quicker, more efficiently, with less exertion by the operator, and with less wear on the operator.

What is claimed is:

1. A strap wrapper comprising:
a) a support plate, the support plate being rectangular with two ends, the one end allows the support plate to attach to an object, the other end is traversed by a double open-ended support channel;
b) a rolling spindle, the rolling spindle having a base that supports a pair of spindle arms having a U-shaped orientation;
c) a spindle driveshaft; the spindle driveshaft having one shaft end and an other shaft end, the spindle driveshaft being movably received within the double-open ended tube, the one shaft end connects to the rolling spindle while the other shaft end to can reversibly connect to a power tool that can rotate the spindle driveshaft, the power tool having a use apart and separate from powering the strap wrapper;
wherein a webbed strap, which is used to reversibly secure loads to a load bearing device, reversibly attaches to the rolling spindle to be coiled when the power tool as attached to the strap wrapper is activated.

2. The strap wrapper of claim 1 wherein the one shaft end and the other shaft end are connected by a central portion, the one shall end and the central portion are sized to allow the one shaft end and the central portion to pass into the double open-ended support channel.

3. The strap wrapper of claim 2 wherein the central portion lays within the double open-ended support channel.

4. The strap wrapper of claim 2 wherein the spindle driveshaft further comprises a retaining collar that connects the central portion to the other shaft end.

5. The strap wrapper of claim 4 wherein the size of the retaining collar prevents the retaining collar from passing through the double open-ended support channel.

6. The strap wrapper of claim 4 wherein the double open-ended support channel is sandwiched between the rolling spindle and the retaining collar to rotatably hold a combination of the rolling spindle and the spindle driveshaft upon the support plate.

7. The strap wrapper of claim 1 wherein the one shaft end is threaded and is received within a threaded base aperture of the rolling spindle.

8. The strap wrapper of claim 1 wherein the spindle driveshaft replaces a hand crank that otherwise attaches to the rolling spindle.

9. The strap wrapper of claim 1 wherein the other shaft end could be of suitable size and shape to allow a chuck of the power tool to reversible attach to the spindle driveshaft.

10. A strap wrapper and power tool combination comprising:
a) a strap wrapper having a support plate, a rolling spindle and a spindle driveshaft, the support plate at one end is traversed by a double open-ended channel that rotatably supports the spindle driveshaft; the spindle driveshaft having two shaft ends, one shaft end attaches rolling spindle while other shaft end allows a power tool to attach to the spindle driveshaft;
b) the power tool having a use apart and separate from powering the strap wrapper, when activated the power tool rotates the spindle driveshaft relative to the double open-ended channel to move the rolling spindle;
wherein a webbing strap as reversibly attached to the rolling spindle is wrapped into a coil when the rolling spindle is rotated by the power tool, the power tool having a use apart and separate from powering the strap wrapper.

11. The combination of claim 10 wherein the one shaft end and the other shaft end are connected by a central portion, the one shaft end and central portion are sized to allow the one shaft end and the central portion to pass into the double open-ended support channel.

12. The combination of claim 11 wherein the central portion lays within double open-ended support channel.

13. The combination of claim 11 further comprising a retaining collar that connects the central portion to the other shaft end.

14. The combination of claim 13 wherein the retaining collar is sized to prevent the retaining collar from passing through the double open-ended support channel.

15. The combination of claim 10 wherein the double open-ended support channel is sandwiched between the rolling spindle and a retaining collar to rotatably hold a combination of the rolling spindle and spindle driveshaft upon the support plate.

16. The combination of claim 10 wherein the one shaft end is threaded and is received within a threaded base aperture of the rolling spindle.

17. The combination of claim 10 wherein the other shaft end could be of suitable configuration and size to be received within a chuck of the power tool to reversibly attach the power tool to the spindle driveshaft.

18. A process for operating a strap wrapper, comprising the following steps but not necessarily in the order presented:
a) providing a support plate having two ends, one end allows the support plate to attach to other objects, a double open-ended support channel traversing an other end;
b) providing a rolling spindle, the rolling spindle having a base that supports a pair of spindle arms having a spaced-apart, opposing, parallel-orientation;
c) providing a spindle driveshaft; the spindle driveshaft having one shaft end and an other shaft end, the spindle driveshaft being movably received in the double open-ended channel, the one shaft end connects to rolling spindle while the other shaft end can reversibly connect to a power tool that can rotate spindle driveshaft;
d) connecting the power tool to the spindle driveshaft to rotate the rolling spindle, the power tool having a use apart and separate from powering the strap wrapper; and
e) attaching to the rolling spindle a webbed strap that can be used to secure a load to a load bearing device; and
f) rotating the spindle driveshaft with the power tool to coil the webbed strap.

19. The process of claim 18 wherein providing a spindle driveshaft that further comprises a step of sandwiching the double open-ended channel between a retaining collar and the rolling spindle.

20. The process of claim 18 further comprising a step of replacing a hand crank that is attached to the rotating spindle with the spindle driveshaft.
